(19) United States
(12) Patent Application Publication
(10) Pub. No.: US 2010/0122558 A1
(43) Pub. Date: May 20, 2010

(54) Apparatus and Method of Sintering an Optical Fiber Preform

(76) Inventors: John Michael Jewell, Wilmington, NC (US); Nicolas LeBlond, Painted Post, NY (US); Mehrdad Mahmoudi, Wilmington, NC (US); Ji Wang, Painted Post, NY (US)

Correspondence Address: CORNING INCORPORATED, SP-TI-3-1, CORNING, NY, 14831, US

(21) Appl. No.: 12/273,958

(22) Filed: Nov. 19, 2008

(51) Int. Cl. C03B 37/025

(52) U.S. Cl. 65/427; 65/508

(57) ABSTRACT

A method and apparatus for consolidating an optical fiber preform, wherein the optical fiber preform is located in a furnace comprising a muffle tube, said muffle tube comprising an inner section and an outer section surrounding the inner section. The inner and outer sections are comprised of different materials, and the preform is exposed to a pressure less than 0.8 atm while simultaneously exposing said preform to a temperature of at least 1000 C.

### BACKGROUND OF THE INVENTION

1. Field of the Invention

This invention relates to a method for sintering a porous optical fiber preform.

2. Technical Background

During the manufacture of transmission optical fibers by conventional soot deposition processes such as the outside vapor deposition (OVD) process or the vapor axial deposition (VAD) process, silica and doped silica particles are pyrogenically generated in a flame and deposited as soot. In the case of OVD, silica soot preforms are formed layer-by-layer by deposition of the particles on the outside of a cylindrical or axial target rod by traversing the soot-laden flame along the axis of the target. Such porous soot preforms are subsequently treated with a drying agent (e.g., chlorine) to remove water and metal impurities and are then consolidated or sintered inside a consolidation furnace into void-free glass blanks at temperatures ranging from 1100-1500° C. Surface energy driven viscous flow sintering is the dominant mechanism of sintering, which results in densification and closing of the pores of the soot, thereby forming a consolidated glass preform with no porosity. The step of consolidating or sintering a preform produces a dense, substantially clear optical fiber preform which is then drawn into the optical fiber. Helium is often the gas utilized as the atmosphere during the consolidation of conventional optical fiber preforms. Because helium is very permeable in glass, it exits the soot preform during the consolidation process, so that after consolidating in helium the glass is typically totally free or substantially free of pores or voids. However, if immediately subjected to high temperatures such as are present in a fiber draw or core cane redraw operation, the helium still dissolved in the consolidated glass can exsolve out of the consolidated glass during the fiber draw process causing the formation of helium filled seeds, which would in turn negatively impact fiber quality. Consequently, gases (e.g. helium gas) which are dissolved in the consolidated preform after the consolidation phase of the fiber manufacturing process are sometimes outgassed by holding the fiber preforms for a period until the gases migrate out through the glass preforms.

### SUMMARY OF THE INVENTION

One aspect of the invention relates to a method of consolidating a soot containing optical fiber preform, comprising: locating said optical fiber preform in a furnace comprising a muffle tube, wherein the muffle tube comprises an inner section defining a hollow cylinder, and an outer section surrounding the inner section, wherein the inner and outer sections are comprised of different materials. The soot preform is exposed to a reduced pressure less than atmospheric pressure (i.e. less than about 101 kPa) while simultaneously exposing said preform to a temperature sufficient to filly consolidate or sinter the preform into a void free preform, i.e., typically at least 1000° C., preferably at least 1200° C., more preferably greater than 1350° C., and most preferably greater than 1400° C. The consolidation temperature is preferably less than 1550° C., and in some embodiments less than 1500° C. During the consolidation step, the pressure within the inner section is preferably less than 1 atm (less than 101 kPa), more preferably less than about 0.8 atm (less than 81 kPa), even more preferably between about 0.05 to 0.5 atm (about 5 to 50 kPa) and most preferably between about 0.1 to 0.2 atm (about 10 to 20 kPa). The preform is maintained at these temperatures and pressures for a time sufficient to result in the soot being fully consolidated into a clear glass optical fiber preform.

Another aspect of the invention relates to an apparatus for degassing or consolidating an optical fiber preform, comprising a muffle tube having an inner wall section and an outer wall section surrounding the inner wall section, wherein the inner and outer wall sections are comprised of different materials. The inner and outer sections of said furnace muffle may be combined within a composite material, the inner and outer sections mechanically and/or chemically adhered to one another, or alternatively the inner and outer wall sections may be spaced from one another.

Another aspect relates to a method of consolidating an optical fiber preform, comprising locating at least one soot containing optical fiber preform in a furnace comprising a muffle tube, said muffle tube comprising greater than 95 percent devitrified silica, and exposing said preform to a pressure less than 101 kPa while simultaneously exposing said preform to a temperature of at least 1000° C. sufficient to consolidate said soot containing preform.

In any of the methods or the apparatus disclosed herein, the inner wall section(s) material of the muffle tube preferably is comprised of an inert material such as silica glass, and the outer material is preferably comprised of a material which has higher strength than the inner wall section at the temperatures employed to consolidate the optical fiber preform. For example, the outer wall section material may be selected from the group consisting of ceramic material or graphite. Preferred materials for the inner wall section include silica, silicon carbide, graphite, and combinations thereof. Preferred materials for the outer wall section include ceramic materials such as alumina, zirconia, silicon carbide, graphite, and combinations thereof. The outer wall section may be in contact with the inner wall section, or alternatively these sections may be spaced from one another. Preferably, if the sections are spaced from one another, an adequate pressure is maintained between the inner and outer wall sections so that the inner wall section does not collapse. For example, the pressure maintained between the inner and outer sections may be maintained at about the same pressure that is maintained within the inner section. Furnace design can also be used to achieve the same objective. For example, two or more consolidation chambers each of which are comprised of an inner wall section as described above, could be placed in a closed chamber and the entire device then placed under reduced pressure. The thickness and rigidity of the materials employed for the inner and outer muffle tube materials are preferably selected so that the chamber is able to withstand the reduced pressure employed during consolidation. Another alternative would be for the muffle to be large enough for more than one preform to be consolidated at the same time inside the same muffle.

Using the methods and apparatus disclosed herein, the soot preforms may be consolidated into a dense, clear optical fiber preform. In some previous consolidation techniques, it was desirable to retain fiber preforms after the consolidation step in holding ovens at high temperature for some period of time to allow excess helium to diffuse out of the consolidated glass preform. Otherwise, when the fiber was exposed to the higher temperatures employed during the fiber draw operation (e.g. 2000° C. or higher), rather than escaping from the consolidated glass, the helium would cause seeds to form in the drawn fiber, causing fiber breaks. Such holding oven operations are time consuming and costly, both in terms of added cost to supply heat to the holding ovens, as well as the increased cost associated with an additional manufacturing step. Because the consolidation process of the present invention occurs at less than atmospheric pressure, consolidated glass core canes can be immediately redrawn into a smaller diameter core cane and consolidated glass fiber preforms can be immediately drawn into optical fiber directly after the consolidation process, without having to spend time in a holding oven to outgas excess helium, and without risk of seed formation occurring in the fiber or core cane due to helium coming out of solution within the preform. As used herein, redraw is a process whereby a preform or core cane or other preform precursor has its diameter reduced to a diameter which is considerably greater than the diameter of a drawn fiber, and after which additional soot may be deposited onto the redrawn cane, as is known in the art. The ability to eliminate a post-consolidation holding oven treatment prior to redrawing or drawing a preform into optical fiber derives from the fact that consolidation in a lower partial pressure helium environment results in a dissolved helium concentration which is below the solubility limit at draw or redraw temperatures, i.e., there is no thermodynamic driver for exsolution.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic view of one embodiment of the present invention;

FIG. 2 is a schematic view of an alternative embodiment of the present invention.

### DETAILED DESCRIPTION OF THE PREFERRED EMBODIMENTS

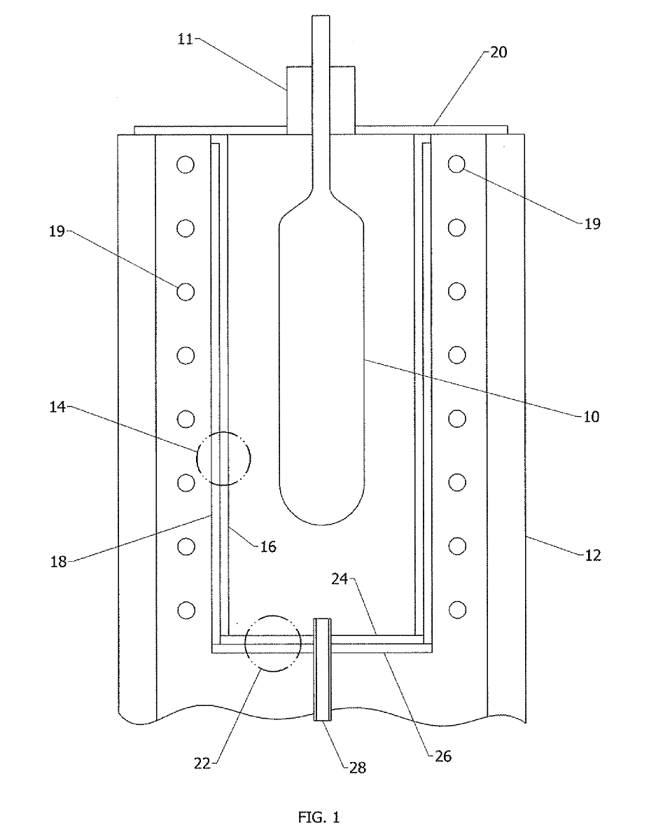

FIG. 1 illustrates a preferred method and apparatus in accordance with the invention. In the embodiment illustrated in FIG. 1, during consolidation of the soot portion of the fiber preform, the porous soot preform 10 is consolidated or sintered in consolidation furnace 12. Soot preform 10 is supported within furnace 12 by preform support 11. In the embodiment illustrated, consolidation furnace 12 is comprised of a furnace muffle 14 which includes an inner sidewall section 16 and outer sidewall section 18. In one preferred embodiment, the inner and outer sidewalls are cylindrical, thereby forming a cylindrical chamber within which the preform 10 is supported. The furnace muffle 14 is surrounded by heating elements 19 which are used to control the temperature within furnace muffle 14. The furnace also includes furnace top hat 20 which in the embodiment illustrated may be comprised of metal, for example aluminum. The inside surface of the top hat (i.e. the surface facing the inside of the muffle) may in some embodiments be comprised of hastelloy or similar stainless steel material. Alternatively, the top hat could be constructed of the same materials employed to make the inner and outer sidewalls 16 and 18. The furnace also includes bottom plate 22 which in the embodiment illustrated is comprised of an inner bottom wall section 24 and outer bottom wall section 26. The muffle 14 together with bottom wall 22 and top hat 20 defines a chamber within which the preform may be dried and consolidated. Preferably, inner sidewall section 16 and inner bottom wall section 24 are made of the same material, and outer sidewall section 18 and outer bottom wall section 26 are made of the same material, although this is not required and these various sections could alternatively be constructed of different materials. Soot preform 10 could be any precursor to an optical fiber containing soot, e.g. a complete optical fiber preform entirely made of soot, or core cane or other preform precursor, i.e., the soot could make up only the core region or other region of an incomplete optical fiber preform. Such core canes can be consolidated according to the invention, after which additional soot (e.g. cladding soot) can be deposited and the resultant preform consolidated to sinter the cladding soot.

The inner sidewall section 16 and inner bottom wall section 24 are in some embodiments preferably comprised of an inert material such as silica glass. By inert material, we mean a material that will not react substantially with the surrounding atmosphere and transfer impurities to the soot preform being consolidated within the furnace such that when an optical fiber is drawn the attenuation or other properties of the potical fiber are negatively impacted. For example, preferred materials for the inner section 16 include silica glass, crystalline silica, silicon carbide, graphite, and combinations thereof. One preferred inert material for the inner wall section 16 and inner bottom section 24 is crystalline (e.g. devitrified) silica. Preferably, the silica is greater than 98 percent, more preferably greater than 98.5 percent and even more preferably greater than 99.5 percent pure silica (either crystalline or glass). In some preferred embodiments, the inner wall section 16 is comprised of entirely devitrified, or crystalline silica. For example, a pure silica glass inner wall material may be converted to devitrified silica by exposing the glass to consolidation temperatures (e.g. 1400 C) for long periods (e.g. months) at a time. The devitrification process can be sped up by exposing the glass silica muffle material to a dopant such as one or more of the alkali metals, or a similar dopant that causes crystallization of silica. The conversion of the silica glass to devitrified silica causes the silica muffle to stiffen considerably (and thus become higher strength), particularly at high temperatures. The outer sidewall section 18 and outer bottom wall section 26 are preferably comprised of a material which has higher strength, i.e., outer sidewall section 18 is made a material which will not deform viscously (e.g. maintains a viscosity of greater than about 10¹⁴ when exposed to a temperature of 1400 C) at the consolidation processing temperatures employed when the pressure on either side of inner material 16 is lower than 1 atm (101 kPa). In this way, the outer wall 18,26 materials can help prevent the inner wall 16,24 materials from collapsing under the pressure differential employed during the consolidation process. Preferred materials for the outer section include ceramic materials such as alumina, zirconia, silicon carbide, graphite, or combinations thereof. In the embodiment illustrated in FIG. 1, the outer wall section 18 is in contact with and preferably mechanically or chemically adhered to the inner wall section 16 and the outer bottom 26 is in contact with said inner bottom section 24. In one particularly preferred embodiment, a high silica content inner material is deposited onto the inside of a suitable outer material that is shaped into a cylinder. For example, the high silica content glass could be deposited using CVD techniques or plasma spray deposition techniques, after which time the silica is sintered to form a furnace muffle 14 which is comprised of an alumina outer section 18, the inside surface of which is adhered to a layer of silica glass which forms inner section 16. By high silica content, we mean greater than 95 percent, more preferably greater than 99 percent silica. During the consolidation step, the soot preform is exposed to helium at a pressure less than atmospheric pressure while simultaneously exposing said preform to a temperature sufficient to fully consolidate or sinter the preform into a void free preform, i.e., greater than 1000° C., preferably greater than 1200° C., more preferably greater than 1350° C., and most preferably greater than 1400° C. The consolidation step preferably occurs at less than 1550° C., more preferably less than 1500° C. During the consolidation step, the pressure within the inner section is preferably less than 1 atm (less than 101 kPa), more preferably between about 0.05 to 0.5 atm (about 5 to 50 kPa) and most preferably between about 0.1 to 0.2 atm (about 10 to 20 kPa). The preform is maintained at these temperatures and pressures for a time sufficient to result in the soot being fully consolidated into a clear glass optical fiber preform. For example, in some embodiments, the preform is maintained in the furnace during the consolidation operation for less than 12 hours, more preferably less than 10 hours. In one particularly preferred embodiment, the preform is exposed to a pressure inside said inner section which is less than 0.5 atm (50 kPa) and a temperature which is greater than 1400° C.

Prior to consolidation, the soot preform preferably undergoes a drying operation. The preform 10 is initially maintained in the consolidation chamber at a temperature high enough to permit the drying reaction to occur but insufficient to cause the preform to consolidate. During this initial drying treatment a carrier gas such as helium flows into the furnace mixed with a drying agent such as chlorine or CO. For example, during the consolidation process, the soot containing preform may preferably exposed to a gas stream of helium mixed with less than 2% drying gas at a total flow rate which is preferably greater than 0.1 slpm and less than 10 slpm, more preferably greater than 1 slpm and less than 5 slpm. Depending on the process, once the drying process has been completed, but prior to the initiation of the consolidation process, the flow of chlorine ceases.

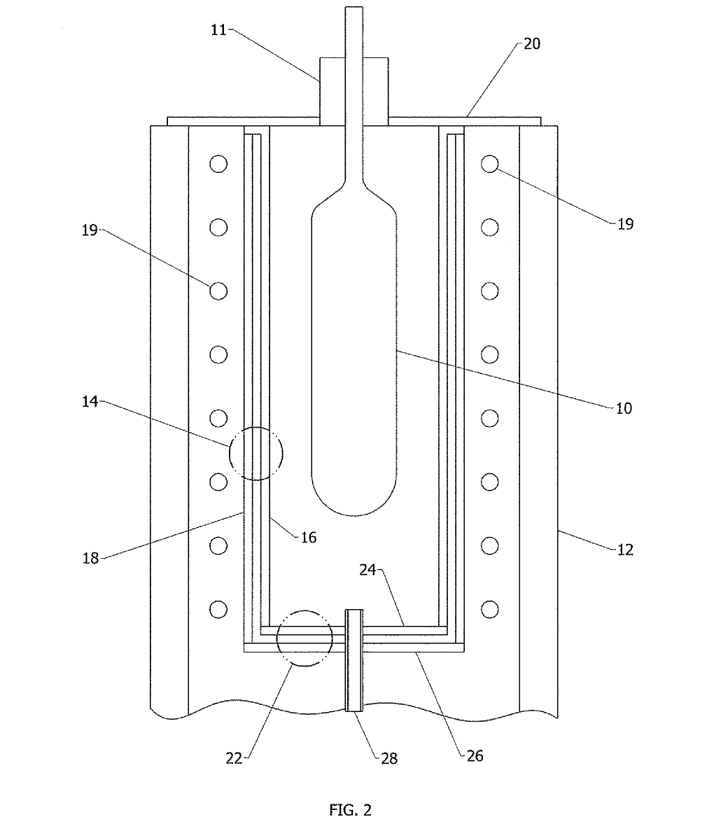

After the drying phase is complete, the furnace temperature can be raised to a temperature which is high enough to cause the soot to consolidate. Two types of consolidation processes can occur, gradient consolidation and bulk consolidation. During gradient consolidation, one end of the preform sinters first, and the sintering then continues toward the other end of the preform. Alternatively, the blank remains stationary within the furnace while the furnace temperature is varied axially. During bulk consolidation, the entire preform is heated to temperatures within the consolidation temperature range. If the preform is isothermally heated, the entire preform can be simultaneously sintered. In one preferred embodiment the preform is subjected to gradient consolidation, whereby the bottom tip of the preform begins to consolidate first, the consolidation continuing up the preform until it reaches that end thereof adjacent tubular support 11. The rate of insertion or zoned temperature ramp is preferably low enough to permit the tip of the preform to consolidate first, the consolidation process then continuing up the preform until it reaches that end of the preform adjacent tubular support 11. The maximum furnace temperature, which is preferably between 1400° C. and 1500° C. for high silica content soot containing preforms, must be adequate to fuse the particles of glass soot and thereby consolidate the soot preform into a dense clear glass body in which no voids exist. Regardless of the heating method employed, in some preferred embodiments, during the consolidation process, helium gas is flowed through the furnace, although other gases could also be employed, for example argon or nitrogen. In the embodiments illustrated in FIGS. 1 and 2, helium is preferably flowed into the furnace through an orifice in the bottom plate 22 and out through an orifice in top plate 20 so that the flow is preferably upward through the muffle of the furnace.

Alternatively, as shown in FIG. 2, the inner sidewall section 16 and outer sidewall section 18 (as well as the inner bottom wall section 24 and the outer bottom wall section 26) may be spaced from one another. Preferably, if the sections are spaced from one another, an adequate pressure is maintained on both sides of the inner wall section(s) so that the inner section does not collapse. For example, the pressure maintained between the first and second sections may be maintained at about the same pressure that is maintained within or inside of the inner wall sections. In some embodiments the inner sidewall (and inner bottom wall) sections may be kept at a slightly higher pressure than the pressure between the inner wall sections and the outer wall sections. For example, this pressure delta (i.e., the difference between the pressure inside the inner sidewall section 16 and the pressure between the inner sidewall 16 and outer 18 sidewall sections) may preferably be between 10-20 inches of water (between 2 to 5 kPa), more preferably between 5-10 inches of water (1.25 to 2.5 kPa) and further, in some of these preferred embodiments, during the consolidation step, the pressure between inner sidewall section 16 and outer sidewall section 18 is preferably below 1 atm (less than 101 kPa), more preferably between about 0.05 to 0.5 atm (about 5 to 50 kPa) and most preferably between about 0.1 to 0.2 atm (about 10 to 20 kPa). In both FIGS. 1 and 2, furnace gases, including one or more doping gases if desired, are fed to the bottom of the consolidation chamber through gas pipe 28 which is affixed thereto. The furnace gases may contain helium and an amount of Cl₂ sufficient to remove hydroxyl ions from the porous preform. In accordance with the method of the present invention, F may also be supplied to the consolidation chamber so that, if desired, the soot may become doped with fluorine. Any suitable compound such as C₂ F₆, C₂ F₂ Cl₂, CF₄, SiF₄ and SF₆ may be employed to supply the F dopant. By taking suitable precautions which are known in the art, fluorine gas (F₂) can also be used.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents. For example, while some embodiments of the invention may be described above in conjunction with the use of He as a consolidation gas, the invention could also be used with other consolidation gases, for example, nitrogen and/or argon or mixtures thereof. Additionally, while some embodiments of the invention are primarily described in terms of a single preform being consolidated within the furnace, alternatively multiple preforms could be consolidated in the same furnace. For example, the internal diameter of the muffle 14 could he large enough to simultaneously consolidate multiple (e.g. 2, 3, or even 4 or more) preforms 10 which are supported therein within the furnace via multiple preform supports 11. Alternatively, multiple furnace muffles comprised of inner sidewalls 16 could be retained within a single outer sidewall 18, and the pressure difference on both sides of the inner sidewall 16 maintained so that inner sidewall 16 does not collapse, as described above.

What is claimed is:

1. A method of consolidating an optical fiber preform, comprising: locating at least one soot containing optical fiber preform in a furnace comprising a muffle tube, said muffle tube comprising an inner wall section, and an outer wall section surrounding the inner wall section, wherein the inner and outer wall sections are comprised of different materials, and exposing said preform to a pressure less than 101 kPa while simultaneously exposing said preform to a temperature of at least 1000° C. for a time sufficient to consolidate said soot containing preform.

2. The method of claim 1, wherein said locating step comprises locating a soot containing optical fiber preform in said furnace, and said method comprises heating said soot containing preform sufficiently to convert said preform into a fully consolidated preform.

3. The method of claim 2, wherein said heating step comprises exposing said preform to a pressure inside said inner wall section which is less than 81 kPa and a temperature which is greater than 1400° C.

4. The method of claim 2, wherein said heating step comprises exposing said preform to a pressure inside said inner wall section which is less than 0.2 atm and a temperature which is greater than 1400° C.

5. The method of claim 3, wherein the outer wall section is comprised of a material selected from the group consisting of ceramic material, graphite, or combinations thereof.

6. The method of claim 3, wherein the inner wall section is comprised of a material selected from the group consisting of silica, silicon carbide, graphite, and combinations thereof.

7. The method of claim 3, wherein the inner wall section is comprised of silica glass or crystalline silica.

8. The method of claim 1, wherein said outer wall section is in contact with said inner wall section.

9. The method of claim 3, wherein said outer wall section is in contact with said inner wall section.

10. The method of claim 3, wherein said outer section is spaced from said inner section, and the difference between the pressure between said inner and outer wall section and the pressure inside said inner wall section is less than 5 to 50 kPa.

11. The method of claim 5, wherein the outer section material is selected from the group consisting of ceramic material or graphite.

12. The method of claim 5, wherein the inner section is comprised of silica and the outer section is comprised of alumina.

13. The method of claim 5, wherein the inner section is comprised of silica and the outer section is comprised of mullite.

14. The method of claim 1, wherein said method comprises locating more than one preform in said furnace, and consolidating said more than one preform simultaneously.

15. The method of claim 14, wherein said furnace comprises multiple inner sections disposed within a single outer section.

16. The method of claim 6, wherein said exposing said preform step comprises maintaining said preform at said pressure and temperature for at least 4 hours.

17. An apparatus for degassing or consolidating an optical fiber preform, comprising a muffle tube having an inner section defining a hollow cylinder, and an outer section surrounding the inner section, wherein the inner and outer sections are comprised of different materials.

18. The apparatus of claim 17, wherein the inner and outer sections of said muffle are a composite material, the inner and outer sections mechanically and/or chemically adhered to one another.

19. The apparatus of claim 18, wherein said inner section is comprised of a material selected form the group consisting of silica glass, silicon carbide, graphite, or combinations thereof.

20. The apparatus of claim 18, wherein said inner section is comprised of silica, and said outer section is comprised alumina.

21. A method of consolidating an optical fiber preform, comprising: locating at least one soot containing optical fiber preform in a furnace comprising a muffle tube, said muffle tube comprising greater than 95 percent devitrified silica, and exposing said preform to a pressure less than 101 kPa while simultaneously exposing said preform to a temperature of at least 1000° C. sufficient to consolidate said soot containing preform.
